(19) United States
(12) Patent Application Publication
(10) Pub. No.: US 2013/0166927 A1
(43) Pub. Date: Jun. 27, 2013

(54) POWER CONTROL SYSTEM AND METHOD

(71) Applicant: CHAO-TSUNG FAN, Tu-Cheng, New Taipei (TW)

(72) Inventor: CHAO-TSUNG FAN, Tu-Cheng, New Taipei (TW)

(73) Assignee: HON HAI PRECISION INDUSTRY CO., LTD., Tu-Cheng (TW)

(21) Appl. No.: 13/600,328

(22) Filed: Aug. 31, 2012

(30) Foreign Application Priority Data
Dec. 21, 2011 (TW) 100147633

(51) Int. Cl. G06F 1/26

(52) U.S. Cl. 713/300

(57) ABSTRACT

The power control system controls a first power unit of an environmental control unit of a server and a second power unit of the server, and includes a receiving unit, a control unit, a warning unit, a determination unit, and a timing unit. When a first operating state of the first power unit is a power-off state and a second operating state of the second power unit is a power-on state, the control unit controls the warning unit to provide a warning signal and controls the timing unit to start a timer. When an elapsed time of the timer reaches a predetermined time, the control unit turns off the server. The disclosure further provides a power control method.

### BACKGROUND

1. Technical Field

The present disclosure relates to a power control system and a power control method, and particularly to a power control system and a power control method for controlling power to a server.

2. Description of Related Art

In order to decrease a temperature of a conventional server system, a cooling system is installed for dissipating heat generated from the server. In addition, uninterruptible power supplies (UPS) are installed for keeping the server and the cooling system operating. However, in the conventional server system, the server uses a UPS and the cooling system uses another UPS. Therefore, when the UPS of the cooling system stops and the UPS of the server is operating, the heat in the server system cannot be immediately dissipated. Thus, the temperature of the server will increase so the stability of the server will decrease.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a server system of the present disclosure.

FIG. 2 is a block diagram of an embodiment of a power control system of the present disclosure.

FIG. 3 is a flowchart of an embodiment of a power control method of the present disclosure.

### DETAILED DESCRIPTION

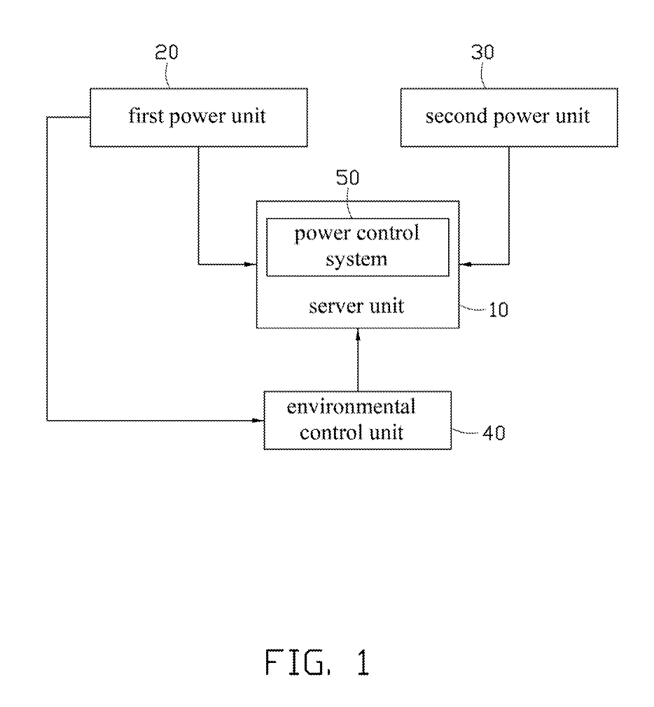

FIG. 1 illustrates a server system in accordance with one embodiment. The server system includes a server unit 10, a first power unit 20, a second power unit 30, and an environmental control unit 40. The server unit 10 further includes a power control system 50. The first power unit 20 supplies power to the environmental control unit 40. The second power unit 30 supplies power to the server unit 10. The environmental control unit 40 controls an environmental parameter of the server unit 10. In the embodiment, the first power unit 20 is a first uninterruptible power supply (UPS), the second power unit 30 is a second UPS, the environmental control unit 40 is a cooling system, and the environmental parameter is a server temperature of the server unit 10.

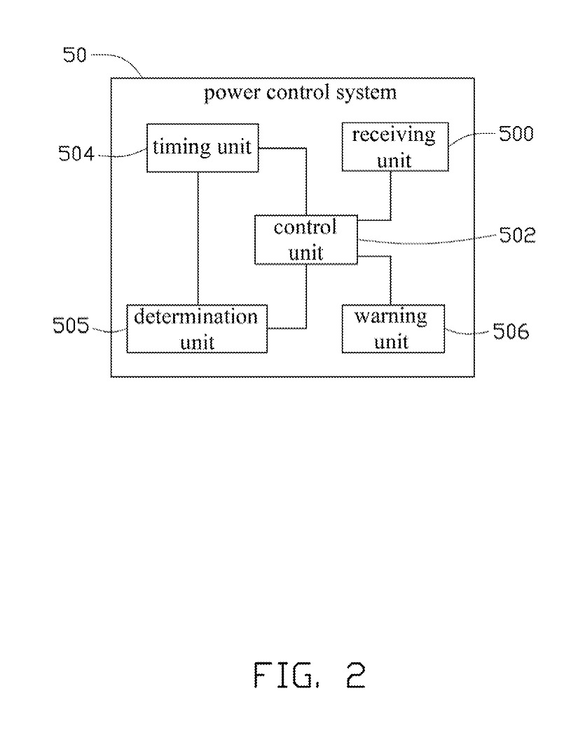

FIG. 2 illustrates the power control system 50 of the embodiment. The power control system 50 includes a receiving unit 500, a control unit 502, a timing unit 504, a determination unit 505, and a warning unit 506. The receiving unit 500 receives a first operating state of the first power unit 20 and a second operating state of the second power unit 30, and transmits the first operating state and the second operating state to the control unit 502. The control unit 502 controls the warning unit 506 and the timing unit 504 according to the first operating state and the second operating state.

When each of the first operating state and the second operating state is a power-on state, the server unit 10 can operate at an appropriate temperature because the environmental control unit 40 cools the server unit 10 continuously. At this time, the receiving unit 500 keeps receiving the first operating state and the second operating state for the server system.

When the first operating state is a power-off state and the second operating state is the power-on state, the temperature of the server unit 10 will increase since heat generated from the server unit 10 cannot be dissipated immediately. At this time, the control unit 502 transmits an activating signal to the warning unit 506. Then, the warning unit 506 receives the activating signal and provides a warning signal, and the warning signal alerts the appropriate technician to check the sever system. Since part of the sever system may be operating abnormally, such as the server unit 10, the first power unit 20, or the environmental control unit 40, the technician needs to ascertain the problem of the server system first and take appropriate actions. Simultaneously, the control unit 502 further transmits a timing signal to the timing unit 504. The timing unit 504 receives the timing signal and then starts a timer. After the technician fixes or eliminates the problem of the server system, the first operating state can be changed as the power-on state. In other words, the first power unit is turned on again. Thus, the server unit 10 can operate at an appropriate temperature again. Therefore, the control unit 502 transmits a stop signal to the timing unit 504. The timing unit 504 receives the stop signal, then stops the timer and resets an elapsed time of the timer. In addition, the control unit 502 further transmits an inactivating signal to the warning unit 506. The warning unit 506 receives the inactivating signal and then stops providing the warning signal.

The determination unit 505 stores a predetermined time and determines whether the elapsed time reaches the predetermined time. When the elapsed time reaches the predetermined time, the determination unit 505 transmits a turn-off signal to the control unit 502. Thus, the control unit 502 immediately turns off the second power unit 30 to turn off the server unit 10. Therefore, the power control system can prevent the server unit 10 from operating at a high temperature. Accordingly, service life of the server unit 10 can increase. In addition, the determination unit 505 further stores a predetermined temperature and determines whether the server temperature reaches the predetermined temperature. When the server temperature reaches the predetermined temperature, the determination unit 505 also transmits the turn-off signal to the control unit 502 to turn off the server unit 10.

When the second operating state is the power-off state and the first operating state is the power-on state, the server unit 10 cannot operate so that the power control system also stops operating.

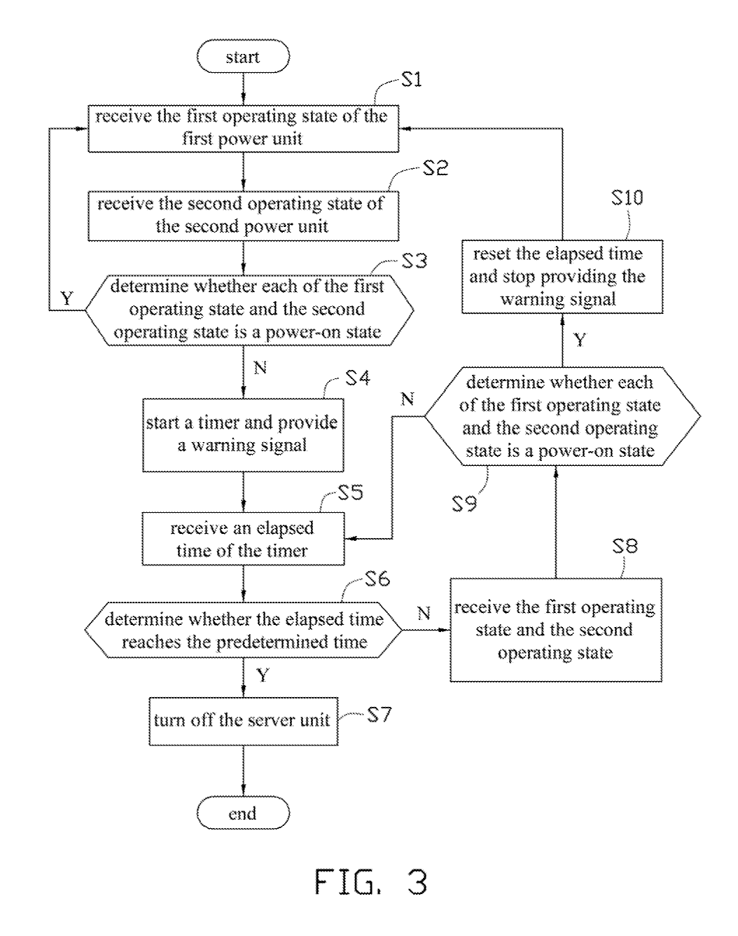

As shown in FIG. 3, an embodiment of the power control method is as follows:

In step S1, the receiving unit 500 receives the first operating state from the first power unit 20. Then, the receiving unit 500 transmits the first operating state to the control unit 502.

In step S2, the receiving unit 500 receives the second operating state from the second power unit 20. Then, the receiving unit 500 transmits the second operating state to the control unit 502.

In step S3, the power control system determines whether each of the first operating state and the second operating state is a power-on state. When each of the first operating state and the second operating state is the power-on state, the procedure returns to step S1. When the first operating state is the power-off state and the second operating state is the power-on state, the procedure goes to step S4.

In step S4, the control unit 502 transmits the timing signal to the timing unit 504 and transmits the activating signal to the warning unit 506. After the timing unit 504 receives the timing signal, the timing unit 504 starts the timer. In addition, the warning unit 506 receives the activating signal to be activated to provide a warning signal.

In step S5, the determination unit 505 receives the elapsed time from the timing unit 504. In addition, the determination unit 505 can further receive the server temperature from the receiving unit 500.

In step S6, the determination unit 505 determines whether to control the control unit 502 to turn off the server unit 10 or not according to the elapsed time. If the elapsed time reaches the predetermined time, the procedure goes to step S7. If the elapsed time is less than the predetermined time, the procedure goes to step S8. In another embodiment, the procedure goes to step S7 if the server temperature reaches the predetermined temperature. If the server temperature is less than the predetermined temperature, the procedure goes to step S8.

In step S7, the control unit 502 transmits a turn-off signal to turn off the server unit 10. Thus, the second power unit 30 and the server unit 10 are turned off. Therefore, the power control system can prevent the server unit 10 from operating at a high temperature.

In step S8, the receiving unit 500 continuously receives the first operating state and the second operating state. The control unit 502 receives the first operating state and the second operating state through the receiving unit 500 continuously.

In step S9, the power control system determines whether each of the first operating state and the second operating state is a power-on state. If each of the first operating state and the second operating state is the power-on state, the procedure goes to step 10 since the first power unit 20 is turned on again. If the first operating state is the power-off state and the second operating state is the power-on state, the procedure returns to step S5.

In step 10, the control unit 502 transmits a stop signal to the timing unit 504 and transmits an inactivating signal to the warning unit 506. The timing unit 504 receives the stop signal to stop the timer and to reset the elapsed time. In addition, the warning unit 506 receives the inactivating signal to stop providing the warning signal.

In this embodiment, the power control system of the server unit 10 cannot operate if the second operating state is a power-off state. Thus, the power control method is only operated when the second operating state is a power-on state, so the determination for the second power unit 30 in steps S3 and S9 must be that the second operating state is the power-on state. Accordingly, the power control system can only determine whether the first operating state is a power-on state or not in steps S3 and S9 and control the server unit 10 only according to the first operating state.

The above power control system and method is operated by receiving the operating states of the power units to control the power units. The power control system provides a warning signal for reminding the employee to check the server system when the power unit of the environmental control unit does not operate. In addition, the power control system further uses a timer to count time when the power unit of the environmental control unit stops. When the elapsed time reaches the predetermined time and the environmental control unit still stops, the power control system directly turns off the server system to prevent the server from operating at a high temperature. Accordingly, the service life of the server can increase.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power control system for controlling power to a server unit, comprising:
a receiving unit configured to receive a first operating state of a first power unit and a second operating state of a second power unit, wherein the first power unit supplies power to an environmental control unit for controlling an environmental parameter of the server unit, and the second power unit supplies power to the server unit;
a warning unit configured to provide a warning signal; and
a control unit configured to activate the warning unit when the first operating state is a power-off state and the second operating state is a power-on state.

2. The power control system of claim 1, further comprising:
a determination unit configured to determine whether to control the control unit to turn off the server unit.

3. The power control system of claim 2, further comprising:
a timing unit configuring to start a timer when the first operating state is the power-off state and the second operating state is the power-on state.

4. The power control system of claim 3, wherein the determination unit controls the control unit to turn off the server unit when an elapsed time of the timer reaches a predetermined time.

5. The power control system of claim 3, wherein the timing unit stops and resets when the first power unit is turned on.

6. The power control system of claim 2, wherein the determination unit controls the control unit to turn off the server unit when the environmental parameter received through the receiving unit reaches a predetermined parameter.

7. The power control system of claim 6, wherein the environmental parameter is a server temperature of the server unit, and the predetermined parameter is a predetermined temperature.

8. The power control system of claim 1, wherein the first power unit includes a first uninterruptible power supply (UPS), and the second power unit includes a second UPS.

9. The power control system of claim 8, wherein the first operating state is the power-off state when the first UPS stops supplying power; and the second operating state is the power-on state when the second UPS is operating.

10. A power control method for controlling power to a server unit, comprising:
receiving a first operating state of a first power unit and a second operating state of a second power unit, wherein the first power unit supplies power to an environmental control unit for controlling an environmental parameter of the server unit, and the second power unit supplies power to the server unit; and
providing a warning signal when the first operating state is a power-off state and the second operating state is a power-on state.

11. The power control method of claim 10, further comprising:
starting a timer when the first operating state is a power-off state and the second operating state is a power-on state.

12. The power control method of claim 11, further comprising:
receiving an elapsed time of the timer;
comparing the elapsed time with a predetermined time; and
turning off the server unit when the elapsed time reaches the predetermined time.

13. The power control method of claim 11, further comprising:
determining whether the first power unit is turned on; and
stopping the timer and the warning unit and resetting the timer when the first power unit is turned on.
